(19) United States
(12) Patent Application Publication
(10) Pub. No.: US 2022/0219353 A1
(43) Pub. Date: Jul. 14, 2022

(54) NOVELTY IN MECHANICAL STABILIZATION MIXER

(71) Applicant: ELKON ELEVATÖR KONVEYÖR MAKIA SANAYI VE TICARET ANONIM SIRKETI, Esentepe, Sisli (TR)

(72) Inventor: Bülent GENÇ, Kapakli, Tekirdag (TR)

(21) Appl. No.: 17/604,893

(22) PCT Filed: Dec. 31, 2020
(86) PCT No.: PCT/TR2020/051484

§ 371 Date: Oct. 19, 2021

(30) Foreign Application Priority Data
Feb. 10, 2020 (TR) 2020/01942

(51) Int. Cl. B28C 5/14

(52) U.S. Cl. CPC B28C 5/146

(57) ABSTRACT

A mechanical stabilization mixer used in road infrastructure preparation plants includes a mixer body keeping all structure together, at least two shafts in rotating structure inside the mixer body and a reducer providing driving to the shafts. The mixing arms and mixing palettes of adequate and specially designed number in a manner directing material to the output mouth located in the centre while mixing material to be mixed homogenously and effectively. A material inlet primary mouth and material inlet second mouth are provided facing each other wherein material to be mixed is taken into the mixer body and the outlet mouth located in the centre.

### THE RELATED ART

Invention relates to mechanical stabilization mixer used in road infrastructure material preparation plants.

Invention particularly relates to mechanical stabilization mixer to be used for mixing materials at road infrastructure preparation plants and providing some advantages with its new structure.

### BACKGROUND OF THE RELATED ART

Mechanical stabilization mixer is a unit mixing mechanical materials used in infrastructure of roads.

Today Mixers conducting mixing constantly are designed as systems wherein materials to be mixed enter from one single point, mixing is provided along a long path and also mixed product leave the system from one single point.

Said system used in the related art has some disadvantages not preferred by enterprise. First of all, long production path occupies considerably big area in production field and restricts the enterprise in several aspects. Constructive structure where mixture is placed adversely impacts design and causes structures bigger unnecessarily and increased costs and need for bigger area for locations. If the structure is placed onto a mobile vehicle, its transport is difficult and difficulties regarding change of place are encountered.

Said system used in the related art causes long production periods because of long mixing path. In addition, it does not provide mixture of required level of homogeneity.

During patent search conducted for this purpose, no similar patent application is encountered and documents numbered TR 2018 00808 are related to the present art.

The document numbered TR 2018 00808 summarizes “Invention relates to bucket concrete station used in concrete need of construction sector, producing concrete swiftly, providing saving in area significantly, reducing energy used, controlled load distribution, offering easy transport and allowing application and mobile-fixed, compact way. The invention particularly relates to bucket concrete plant comprising counter weight system used in reaching aggregate filled bucket to mixer in concrete plant. Invention does mention any improvement in connection with the mixer.

In conclusion, developments have been made in mechanical stabilization mixer and, therefore, new embodiments eliminating the above disadvantages and offering solutions to existing problems are needed.

### PURPOSE OF THE INVENTION

The present invention relates to mechanical stabilization mixer meeting the needs mentioned above, eliminating all disadvantages and providing some additional advantages.

Primary purpose of invention is to provide more quality products in a short time and increase general production efficiency, by eliminating some disadvantages upon improvement of mixing system used in the related art.

Another purpose of the invention is to offer an easy and lower cost transport by help of smaller product in comparison to equivalents used in the related art.

A further purpose of the invention is to provide a faster production by help of capability to make feed of material from two points and having short mixing line.

Another purpose of the invention is to disclose an embodiment capable to provide product mixed homogenously at desired level by help of structure of long mixing arms, structure of pallets in the mixer and taking material from ends mixing and forwarding to mid-area and providing exit of product therefrom.

In order to achieve above mentioned and to be understood better from below detailed described all advantages, this present invention relates to a mechanical stabilization mixer used inroad infrastructure preparation plants, comprising a mixer body keeping all structure together, at least two shafts in rotating structure inside mixer body and reducer providing driving to shafts and characterized in comprising mixer arms of adequate number designed in a manner directing material to output mouth while mixing it homogenously and effectively and mixer pallets, at least two inlet and at least two outlet mouths facing each wherein material to be mixed is taken inside mixer body.

The structural and characteristic features and all advantages of the invention will be understood better in the figures given below and the detailed description by reference to the figures. Therefore, the assessment should be made based on the figures and taking into account the detailed descriptions.

### BRIEF DESCRIPTION OF FIGURES

In order to make the embodiment and additional members being subject of the present invention as well as the advantages clearer for better understanding, it should be assessed with reference to the fallowing described figures.

FIG. 1 is a top perspective view of mechanic stabilization mixer

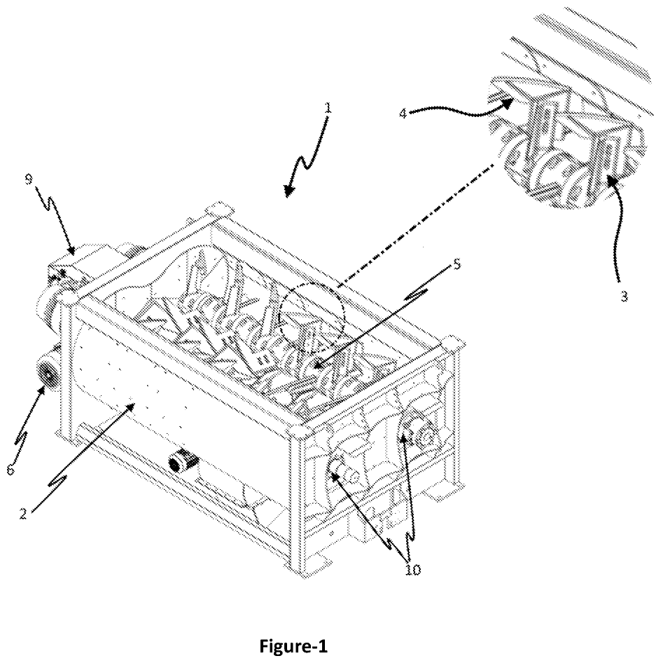

FIG. 2 is a bottom perspective view of mechanic stabilization mixer

FIG. 3 is a side view of mechanic stabilization mixer.

### REFERENCE NUMBERS

1. Mixer

2. Mixer body

3. Mixing arm

4. Mixing palette

5. Shaft

6. Reducer

7. Outlet mouth

8.1 Material inlet primary mouth

8.2. Material inlet second mouth

9. Reducer casing

10. Shaft housing

### DETAILED DESCRIPTION OF THE INVENTION

In this detailed description, the preferred embodiments of the mechanical stabilization mixer (1) being subject of the invention have been described in a manner not forming any restrictive effect and only for purpose of better understanding of the matter.

Mixer (1) of the invention comprises a mixer body (2) mainly keeping all structure together, at least two shafts (5) of rotating structure connected to shaft housing s (10) located on mixer body (2), mixing arms (3) located on shaft (5) and helping mixing operation, mixing palettes (4) located on mixing arms (3) and performing main mixing operation, reducer (6) providing rotation movement to shafts (5), reducer casing (9) providing protection for reducer, material inlet primary mouth (8.1) where material to be mixed is taken into mixer (1) and material inlet second mouth (8) and at least one outlet mouth (7) located under mixer (1) and where end product is taken.

Material to be mixed taken inside mixer (1) from material inlet primary mouth (8.1) and material inlet second mouth (8.2) starts to undergo process in the section where shafts (5) driven by reducer (6) are. Mixing arms (3) and mixing palettes (4) located on shafts (5) provided inside mixer body (2) are specially designed to provide both effective, homogenous mixing and direct materials taken from inlet mouth (8) to outlet mouth (7).

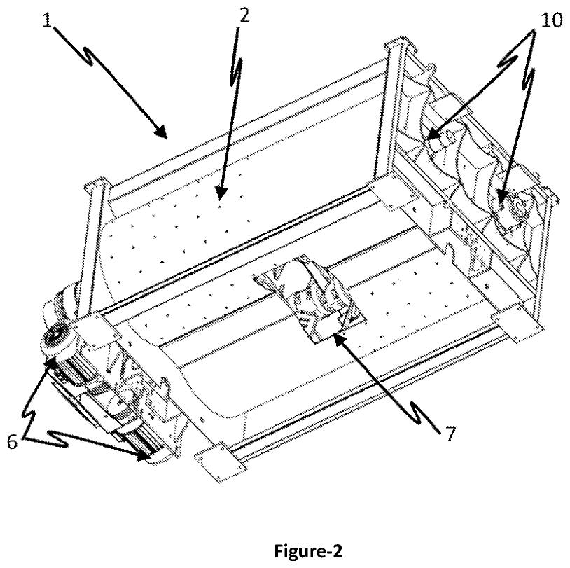

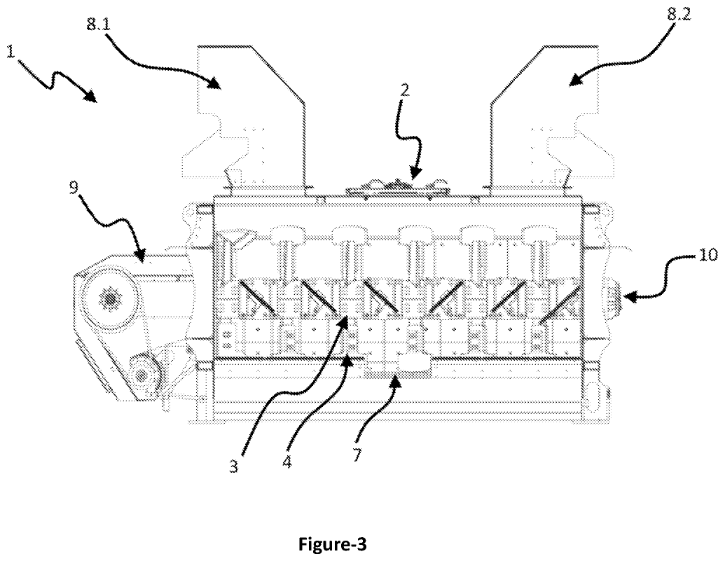

FIG. 3 shows top close view of mixer (1). The material taken from material inlet mouths facing each seen therein is taken into outlet mouth (7) seen in FIG. 2 after mixing inside mixer body (2) at desired level. For the sake of performing fundamental function of mixing in the best way, said mixer (1) is designed as possible as plain and to minimize potential faults that might occur.

Mixing arms (3) and mixing palettes (4) located on shaft (5) are fixed to shaft (5) by screwing method allowing dismantling and replacing with new one in deformation cases that might occur.

1. A mechanical stabilization mixer used in road infrastructure preparation plants, comprising a mixer body keeping all structure together, at least two shafts in rotating structure inside the mixer body and a reducer providing driving to the shafts, arms of adequate number designed in a manner to material to outlet mouth at the same time while mixing it homogenously and effectively and mixing palettes characterized in comprising:
a material inlet primary mouth and a material inlet second mouth facing each wherein material to be mixed are taken from end parts of the mixer body;
an outlet mouth providing exit of material driven and progressed by said mixing arm and mixing palettes from the mixer body.

2. The mechanical stabilization machine according to claim 1, wherein the mixing arms and mixing palettes located on shafts being in structure to mix material in homogenous way effectively and direct to outlet mouth.
